(19) United States
(12) Patent Application Publication
(10) Pub. No.: US 2015/0054707 A1
(43) Pub. Date: Feb. 26, 2015

(54) ANTENNA APPARATUS

(71) Applicant: DENSO CORPORATION, Kariya-city, Aichi-pref. (JP)

(72) Inventors: Yuji Sugimoto, Kariya-city (JP); Tadao Suzuki, Kariya-City (JP); Hiroyuki Izumi, Kariya-City (JP)

(21) Appl. No.: 14/384,077

(22) PCT Filed: Mar. 8, 2013
(86) PCT No.: PCT/JP2013/001488

§ 371 Date: Sep. 9, 2014

(30) Foreign Application Priority Data
Mar. 16, 2012 (JP) 2012-060328

(51) Int. Cl. H01Q 1/38; H01Q 9/30

(52) U.S. Cl. CPC H01Q 1/38; H01Q 9/30
USPC 343/846

(57) ABSTRACT

An antenna apparatus includes a conductive ground pattern formed on a planar substrate and a linear antenna element electrically connected with the ground pattern. The antenna element includes a base end portion, a front end portion, and a feeding point. The antenna element is parallel to the substrate, and the base end portion is connected with an end portion of the ground pattern so that the antenna element is away from the ground pattern. An auxiliary ground pattern having the same potential with the ground pattern is disposed on the substrate between the ground pattern and the antenna element along a side including the end portion.

### CROSS REFERENCE TO RELATED APPLICATION

This application is based on Japanese Patent Application No. 2012-060328 filed on Mar. 16, 2012, the disclosure of which is incorporated herein by reference.

### TECHNICAL FIELD

The present disclosure relates to an antenna apparatus that includes a conductive ground pattern formed on a planar substrate and a linear antenna element electrically connected with the ground pattern.

### BACKGROUND ART

For example, patent literature 1 discloses a structure in which a planar antenna having an inversed L-shape is connected with one end of a planar ground pattern and a linear antenna having an inversed F-shape is connected with the other end of the ground pattern.

However, a high frequency current flows through not only the antenna element but also the ground pattern in the structure in which the antenna element is connected with the planar ground pattern as disclosed in patent literature 1. As a result, the ground pattern radiates electromagnetic waves as a part of the antenna element and changes a radiation pattern of the antenna element. In some cases, null point that has a low sensitivity in a horizontal direction is generated and there is a difficulty in acquiring a required directivity. Hereinafter, the null point is also referred to as a sensitivity deterioration point.

### Prior Art Literatures

### Patent Literature

### Patent Literature 1

JP 2004-040596 A

### SUMMARY OF INVENTION

In view of the foregoing difficulties, it is an object of the present disclosure to provide an antenna apparatus that properly provides a required directivity.

According to an aspect of the present disclosure, an antenna apparatus includes a ground pattern having a conductivity and formed on a planar substrate, and an antenna element having a linear shape and electrically connected with the ground pattern. The antenna element has a base end portion, a front end portion, and a feeding point provided at the base end portion. The ground pattern includes an end portion. The base end portion of the antenna element is connected with the end portion of the ground pattern so that the antenna element is parallel to the substrate. The antenna element is disposed so that the antenna element extends in a direction from the base end portion toward the front end portion away from the ground pattern. The antenna element is fed with power by the feeding point provided at the base end portion. An auxiliary ground pattern is disposed on the substrate between the ground pattern and the antenna element. The auxiliary ground pattern is disposed along a side of the ground pattern and has a same potential with the ground pattern, and the side of the ground pattern includes the end portion of the ground pattern.

In the above antenna apparatus, the auxiliary ground pattern is disposed between the antenna element and the ground pattern. With this configuration, the high frequency current also flows through the ground pattern. However, the high frequency current flowing through the ground pattern can be restricted by disposing the auxiliary ground pattern. As a result, a generation of null points in a required direction is avoided. Further, even though the null points are generated, the null points can be removed from the required direction, and a required directivity can be properly obtained. That is, by disposing the auxiliary ground pattern, an amount of the high frequency current flowing through the ground pattern is adjusted and adverse effect caused by the null points are avoided, and accordingly, the required directivity can be properly obtained.

### BRIEF DESCRIPTION OF DRAWINGS

The above and other objects, features and advantages of the present disclosure will become more apparent from the following detailed description made with reference to the accompanying drawings. In the drawings:

[FIG. 1]

FIG. 1 is a diagram showing a configuration of an antenna according to a first embodiment of the present disclosure;

[FIG. 2]

FIG. 2(a) is a diagram showing a directivity of the antenna according to the first embodiment in a horizontal plane, and FIG. 2(b) is a diagram showing a directivity of the antenna according to the first embodiment in a vertical plane;

[FIG. 3]

FIG. 3 is a diagram showing a configuration of an antenna according to a comparison example;

[FIG. 4]

FIG. 4(a) is a diagram showing a directivity of the antenna according to the comparison example in the horizontal plane, and FIG. 4(b) is a diagram showing a directivity of the antenna according to the comparison example in the vertical plane;

[FIG. 5]

FIG. 5 is a diagram showing a configuration of an antenna according to a second embodiment of the present disclosure;

[FIG. 6]

FIG. 6(a) is a diagram showing a directivity of the antenna according to the second embodiment in the horizontal plane, and FIG. 6(b) is a diagram showing a directivity of the antenna according to the second embodiment in the vertical plane;

[FIG. 7]

FIG. 7 is a diagram showing a configuration of an antenna according to a third embodiment of the present disclosure;

[FIG. 8]

FIG. 8(a) is a diagram showing a directivity of the antenna according to the third embodiment in the horizontal plane, and FIG. 8(b) is a diagram showing a directivity of the antenna according to the third embodiment in the vertical plane;

[FIG. 9]

FIG. 9 is a diagram showing a configuration of an antenna according to a fourth embodiment of the present disclosure;

[FIG. 10]

FIG. 10(a) is a diagram showing a directivity of the antenna according to the fourth embodiment in the horizontal plane, and FIG. 10(b) is a diagram showing a directivity of the antenna according to the fourth embodiment in the vertical plane;

[FIG. 11]

FIG. 11 is a diagram showing a configuration of an antenna according to a fifth embodiment of the present disclosure;

[FIG. 12]

FIG. 12 is a diagram showing a configuration of an antenna according to a sixth embodiment of the present disclosure;

[FIG. 13]

FIG. 13 is a diagram showing a configuration of an antenna according to a seventh embodiment of the present disclosure;

[FIG. 14]

FIG. 14 is a diagram showing a configuration of an antenna according to an eighth embodiment of the present disclosure; and

[FIG. 15]

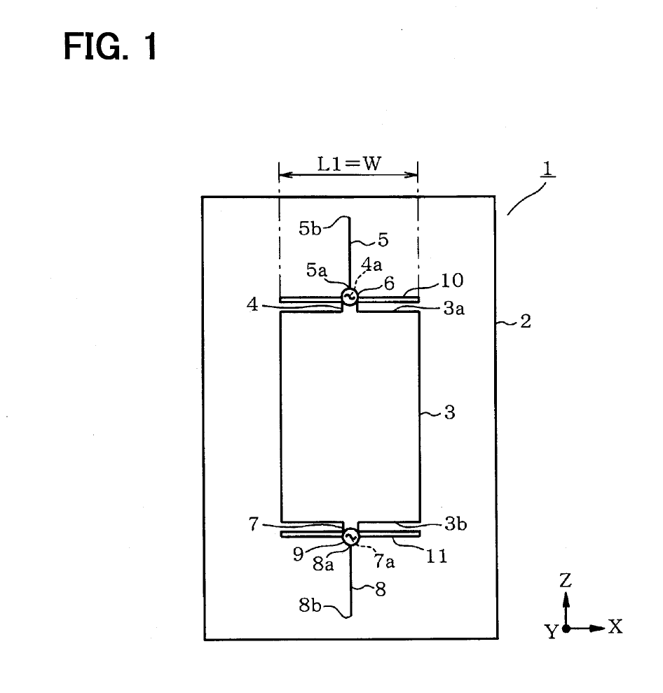

FIG. 1 is a diagram showing a configuration of an antenna according to a ninth embodiment of the present disclosure.

### EMBODIMENTS FOR CARRYING OUT INVENTION

The following will describe embodiments of the present disclosure with reference to the drawings.

### First Embodiment

The following will describe a first embodiment of the present disclosure with reference to FIG. 1 to FIG. 4(b). An antenna apparatus 1 is a vehicle antenna apparatus that is used in a vehicle-to-vehicle communication system that performs communication using, particularly, 5.9 gigahertz (GHz) frequency band. In the antenna apparatus 1, a ground pattern 3 is provided by a conductive pattern (conductive film) formed on a planar substrate 2. The substrate 2 has an approximately rectangular shape. A connection portion 4 is integrally formed with the ground pattern 3. The connection portion 4 is arranged adjacent to one end portion 3a of the ground pattern 3 at a center portion in a horizontal direction (a left-right direction on a sheet of FIG. 1), and protrudes in a vertical direction (an upward direction on the sheet of FIG. 1).

A monopole antenna element 5 has a linear shape, and a base end portion 5a of the antenna element 5 is electrically connected (conductive) with a front end portion 4a of the connection portion 4. The antenna element 5 extends in the vertical direction and is electrically connected with the ground pattern 3. That is, the antenna element 5 is parallel to the substrate 2, and is connected with the connection portion 4 so that the antenna element 5 extends in a direction from the base end portion 5a toward a front end portion 5b away from the ground pattern 3. The antenna element 3 operates with the ground pattern 3 as a ground. The antenna element 5 has a length of, for example, quarter-wavelength of the 5.9 GHz radio wave. Hereinafter, the length of the antenna element 5 is also referred to as an element length. A feeding point 6 that supplies power to the antenna element 5 is provided at the base end portion 5a of the antenna element 5. The antenna element 5 may be shaped to have a predetermined width.

A connection portion 7 is integrally formed with the ground pattern 3. The connection portion 7 is arranged adjacent to another end portion 3b of the ground pattern 3 at the center portion in the horizontal direction, and protrudes in the vertical direction (a downward direction on the sheet of FIG. 1). A monopole antenna element 8 has a linear shape, and a base end portion 8a of the antenna element 8 is electrically connected (conductive) with a front end portion 7a of the connection portion 7. The antenna element 8 extends in the vertical direction and is electrically connected with the ground pattern 3. That is, the antenna element 8 is also connected with the connection portion 7 so that the antenna element 8 extends in a direction from the base end portion 8a toward a front end portion 8b away from the ground pattern 3. The antenna element 8 operates with the ground pattern 3 as a ground. The antenna element 8 also has a length of, for example, quarter-wavelength of the 5.9 GHz radio wave. A feeding point 9 that supplies power to the antenna element 8 is provided at the base end portion 8a of the antenna element 8. The antenna element 8 may be shaped to have a predetermined width.

The antenna elements 5 and 8 are disposed symmetrically in the vertical direction with a center portion of the ground pattern 3 as a center of symmetry. The antenna elements 5 and 8 receive radio waves of 5.9 GHz band by performing a diversity reception, and are selectively supplied with power. For example, each of the feeding points 6 and 9 may be provided by a coaxial cable. An inner conductor of each coaxial cable (not shown) is connected with each of the base end portions 5a and 8a of respective antenna elements 5 and 8, and an outer conductor of each coaxial cable is connected with the ground pattern 3.

A different ground pattern 10 having a linear shape is disposed adjacent to the base end portion 5a of the antenna element 5, and is integrally connected with the connection portion 4 of the ground pattern 3. That is, the different ground pattern 10 and the ground pattern 3 have the same potential. The different ground pattern 10 is provided by a conductive pattern formed on the substrate 2. The different ground pattern 10 is disposed along an upper side of the ground pattern 3 so that the different ground pattern 10 is approximately parallel to an upper side of the ground pattern 3. The different ground pattern 10 is disposed symmetrically in the horizontal direction with the base end portion 5a of the antenna element 5 as a center of symmetry. In the above description, approximately parallel to includes a case in which a distance between the different ground pattern 10 and the upper side of the ground pattern 3 has a constant value and also includes a case in which the distance varies within a predetermined range. That is, for example, a distance between the different ground pattern 10 and the upper side of the ground pattern 3 may have a minimum value adjacent to the center portion of the ground pattern 3, and may have maximum values adjacent to a right portion and a left portion of the ground pattern 3.

Similarly, a different ground pattern 11 having a linear shape is disposed adjacent to the base end portion 8a of the antenna element 8, and is integrally connected with the connection portion 7 of the ground pattern 3. That is, the different ground pattern 11 and the ground pattern 3 have the same potential. The different ground pattern 11 is provided by a conductive pattern formed on the substrate 2. The different ground pattern 11 is disposed along a lower side of the ground pattern 3 so that the different ground pattern 11 is approximately parallel to the lower side of the ground pattern 3. The different ground pattern 11 is disposed symmetrically in the horizontal direction with the base end portion 8a of the antenna element 8 as a center of symmetry. In this case, approximately parallel to includes a case in which a distance between the different ground pattern 11 and the lower side of the ground pattern 3 has a constant value and also includes a case in which the distance varies within a predetermined range. That is, for example, a distance between the different ground pattern 11 and the lower side of the ground pattern 3 may have a minimum value adjacent to the center portion of the ground pattern 3, and may have maximum values adjacent to the right portion and the left portion of the ground pattern 3.

Each of the different ground patterns 10 and 11 has a length L1 in the horizontal direction, and the length L1 is approximately equal to a length W of each of the upper side and the lower side of the ground pattern 3. For example, when each of the upper side and the lower side of the ground pattern has a length of 15 millimeters (mm), each of the different ground patterns 10 and 11 may have a length of 15 mm in the horizontal direction. The ground pattern 3, the antenna elements 5 and 8, the different ground patterns 10 and 11 are disposed on the same plane. The different ground patterns 10 and 11 are also referred to as auxiliary ground patterns.

The antenna apparatus 1 having above-described structure is disposed in a housing (not shown) so that axes of the antenna elements 5 and 8 are in the vertical direction. The antenna elements 5 and 8 are equipped to a vehicle so that the axes of the antenna elements are in the vertical direction by attaching the housing to a roof of a vehicle (not shown). Hereinafter, an axis parallel to the axes of the antenna elements 5 and 8 is defined as a Z axis, an axis parallel to the horizontal direction (the left-right direction on the sheet of FIG. 1) is defined as an X axis, and an axis perpendicular to the Z axis and the X axis is defined as a Y axis. A plane perpendicular to the Z axis is a horizontal plane, and is also referred to as an X-Y plane. A plane perpendicular to the Y axis is a vertical plane, and is also referred to as an X-Z plane. That is, in the antenna apparatus 1 used in the vehicle-to-vehicle communication system, a directivity is required in the horizontal plane (X-Y plane) that is perpendicular to a Z axis direction. The Z axis direction is parallel to directions of the axes of the antenna elements 5 and 8. Hereinafter, a directivity in the X-Y plane is also referred to as a horizontal plane directivity, and a directivity in the X-Z plane is also referred to as a vertical plane directivity.

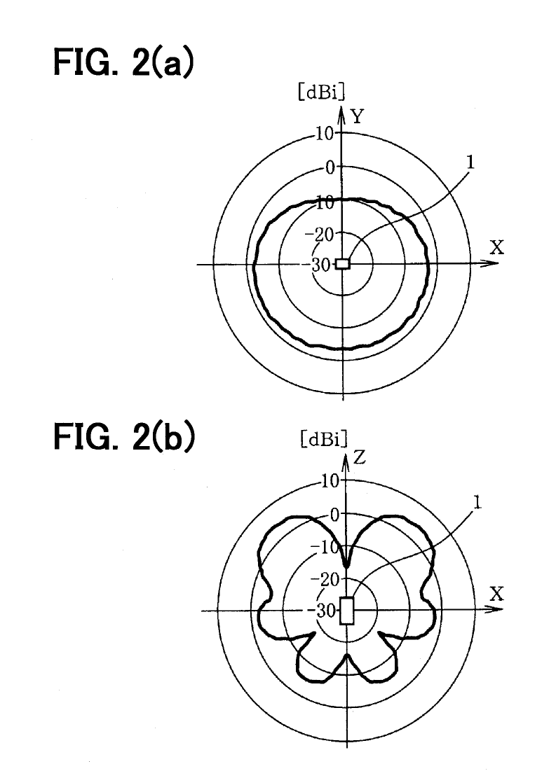

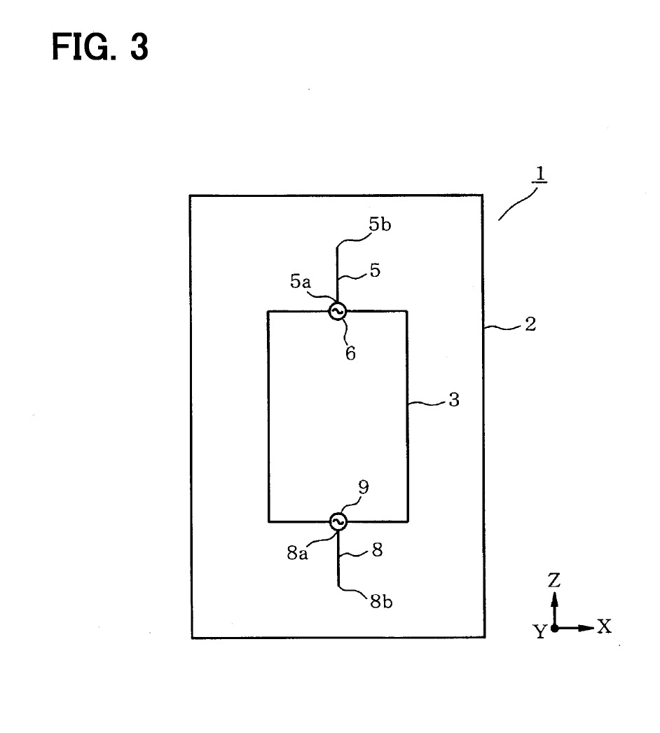

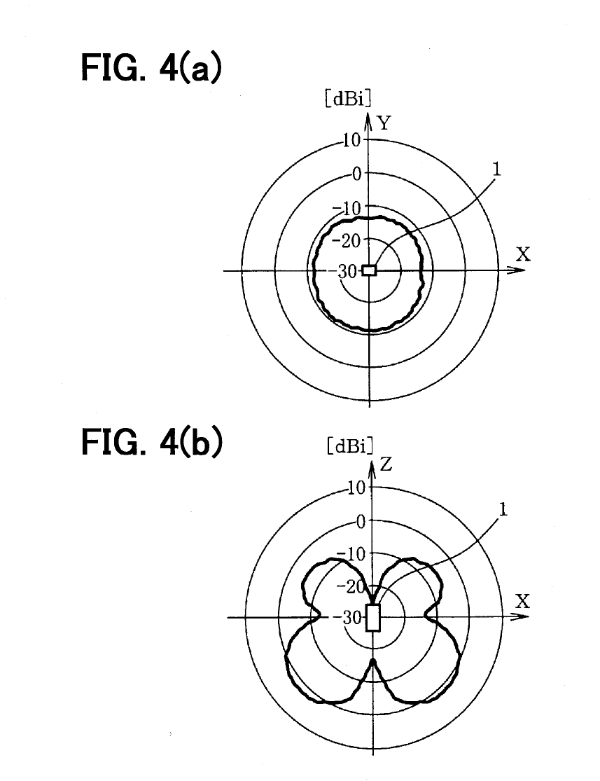

FIG. 2(a) and FIG. 2(b), respectively, show simulation results of a horizontal plane directivity and a vertical plane directivity of the configuration shown in FIG. 1. FIG. 4(a) and FIG. 4(b), respectively, show simulation results of a horizontal plane directivity and a vertical plane directivity of a configuration shown in FIG. 3. In the configuration shown in FIG. 3, the different ground patterns 10 and 11 are omitted compared with the configuration shown in FIG. 1. When the different ground patterns 10 and 11 are disposed, a gain in an X axis direction and a gain in a Y axis direction in the simulation result of the horizontal plane directivity are improved compared with the configuration in which the different ground patterns 10 and 11 are not disposed. In the configuration in which the different ground patterns 10 and 11 are not disposed, null points having low sensitivities are generated on the X axis of the simulation result of the vertical plane directivity. In the configuration in which the different ground patterns 10 and 11 are disposed, a generation of the null points on the X axis is avoided. That is, in the configuration in which the different ground patterns 10 and 11 are disposed, the null points are removed from the X axis.

In a relation between the antenna element 5 and the ground pattern 3, a size of the ground pattern 3 is limited by a mounting performance, and a length of the monopole antenna element 5 cannot be sufficiently secured with respect to a wavelength of the radio wave received by the monopole antenna element 5. Thus, the ground pattern 3 provides a limited ground with respect to the monopole antenna element 5. Under this condition, when the different ground pattern 10 is not disposed between the ground pattern 3 and the antenna element 5, a high frequency current flows through not only the antenna element 5 but also the ground pattern 3. As a result, the ground pattern 3 also radiates electromagnetic waves as a part of the antenna element 5 and changes a radiation pattern of the antenna element 5. Accordingly, a required directivity cannot be obtained.

In a configuration where the different ground pattern 10 is disposed between the antenna element 5 and the ground pattern 3 as disclosed in the present disclosure, the high frequency current still flows through the ground pattern 3. However, the high frequency current flowing through the ground pattern 3 is restricted by disposing the different ground pattern 10. As a result, a generation of the null points in the required direction is avoided. Further, even though the null points are generated, the null points can be removed from the required direction, and the required directivity can be obtained. A relation among the antenna element 8, the ground pattern 3, and the different ground pattern 11 is similar to the above-described relation.

As described above, according to the first embodiment, in a configuration where the planar ground pattern 3 is connected with the monopole antenna elements 5 and 8, the different ground patterns 10 and 11 are disposed between the antenna elements 5 and 8 and the ground pattern 3. With this configuration, the high frequency current flows through not only the antenna elements 5 and 8 but also the ground pattern 3. However, the high frequency current flowing through the ground pattern 3 can be restricted by disposing the different ground patterns 10 and 11. As a result, a generation of the null points in the required direction is avoided. Further, even though the null points are generated, the null points can be removed from the required direction, and the required directivity can be obtained. That is, by disposing the different ground patterns 10 and 11, an amount of the high frequency current flowing through the ground pattern 3 is adjusted and adverse effect caused by the null points are avoided, and accordingly, the required directivity can be properly obtained.

### Second Embodiment

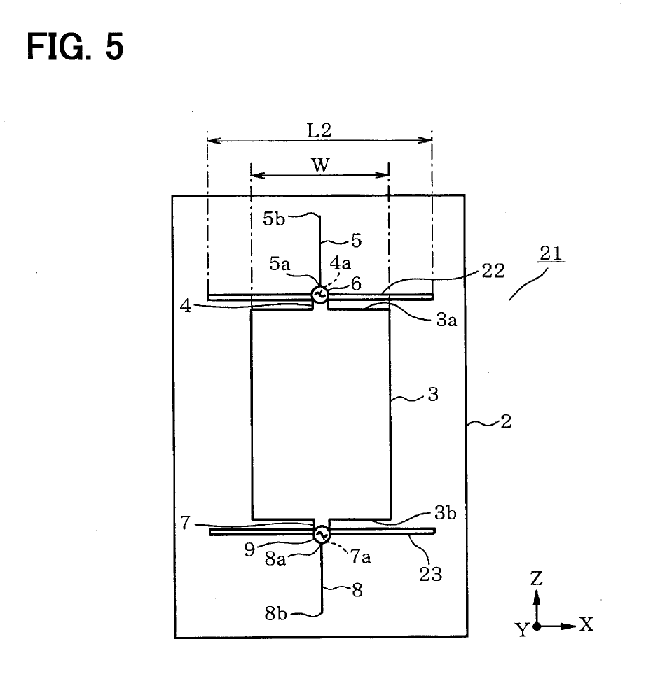

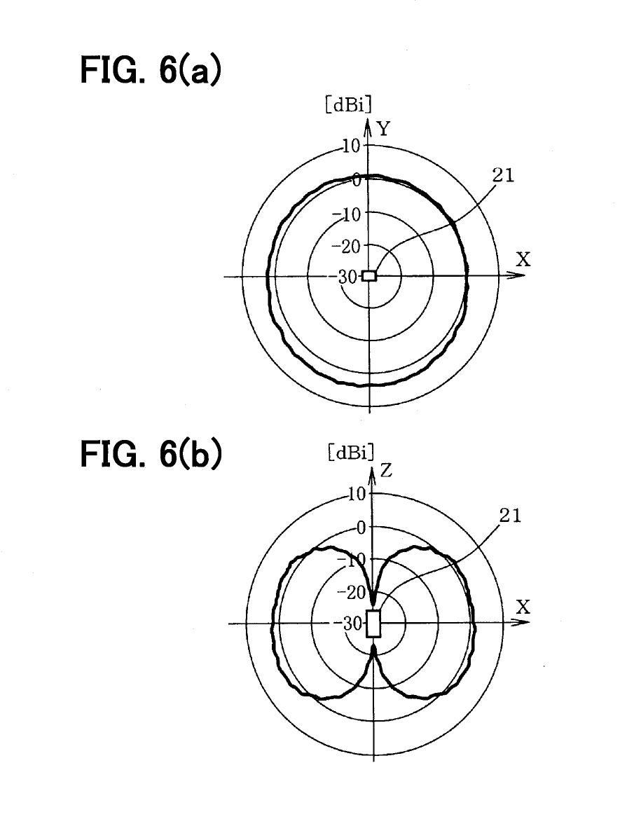

The following will describe a second embodiment of the present disclosure with reference to FIG. 5 to FIG. 6(b). A description of the same part with the above-described first embodiment will be omitted, and different parts will be described. A shape of the different ground pattern according to the second embodiment is different compared with the first embodiment.

According to the second embodiment, as shown in FIG. 5, in an antenna apparatus 21, each of different ground patterns 22 and 23 has a length L2 in the horizontal direction. The length L2 is longer than the length W of each of the upper side and the lower side of the ground pattern 3. For example, when each of the upper side and the lower side of the ground pattern has a length of 15 mm, each of the different ground patterns 22 and 23 may approximately have a length of 19 mm in the horizontal direction. FIG. 6(a) and FIG. 6(b), respectively, show simulation results of a horizontal plane directivity and a vertical plane directivity of the configuration shown in FIG. 5.

In the configuration shown in FIG. 5, compared with the first embodiment in which each of the different ground patterns 10 and 11 has approximately same length with a parallel side of the ground pattern 3, each of the different ground patterns 22 and 23 has a longer length than the parallel side of the ground pattern 3. Thus, a gain in the X axis direction and a gain in the Y axis direction in the simulation result of the horizontal plane directivity are further improved. Further, a generation of the null points on the X axis is avoided in the simulation result of the vertical plane directivity, and the gain in the X axis is properly secured. The second embodiment provides advantages similar to the advantages acquired by the first embodiment.

### Third Embodiment

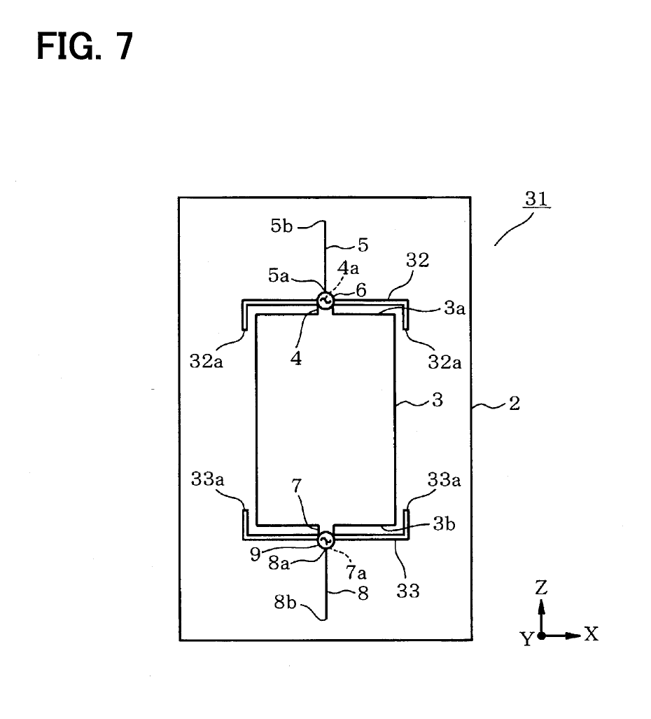

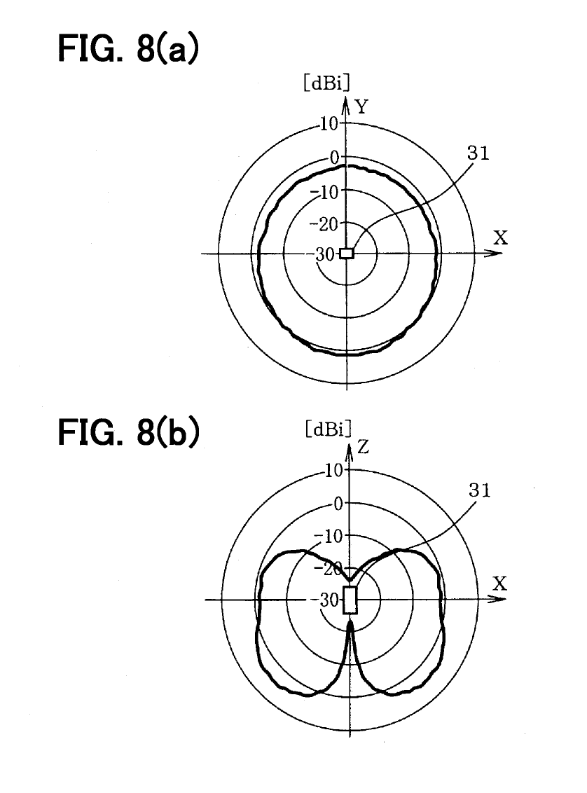

The following will describe a third embodiment of the present disclosure with reference to FIG. 7 to FIG. 8(b). A description of the same part with the above-described first embodiment will be omitted, and different parts will be described. A shape of the different ground pattern according to the third embodiment is different compared with the first embodiment.

According to the third embodiment, as shown in FIG. 7, in an antenna apparatus 31, in the horizontal direction, each of different ground patterns 32 and 33 has a length longer than a length of each of the upper side and the lower side of the ground pattern 3. Further, each of front end portions 32a and 33a of the different ground patterns 32 and 33 has a bent shape so that each of the front end portions 32a and 33a is bent at an approximate right angle toward the ground pattern 3. FIG. 8(a) and FIG. 8(b), respectively, show simulation results of the horizontal plane directivity and the vertical plane directivity of the configuration shown in FIG. 7.

In the configuration shown in FIG. 7, compared with the first embodiment in which each of the different ground patterns 10 and 11 has approximately same length with the parallel side of the ground pattern 3, each of the different ground patterns 32 and 33 has a longer length than the parallel side of the ground pattern 3 and each of the front end portions 32a and 33a is bent toward the ground pattern 3. Thus, a gain in the X axis direction and a gain in the Y axis direction in the simulation result of the horizontal plane directivity are further improved. Further, a generation of the null points on the X axis is avoided in the simulation result of the vertical plane directivity, and the gain in the X axis is properly secured. The third embodiment provides advantages similar to the advantages acquired by the first embodiment. Further, since the front end portions 32a, 33a of the different ground patterns 32 and 33 are bent at approximate right angles toward the ground pattern 3, a size in the horizontal direction is reduced.

### Fourth Embodiment

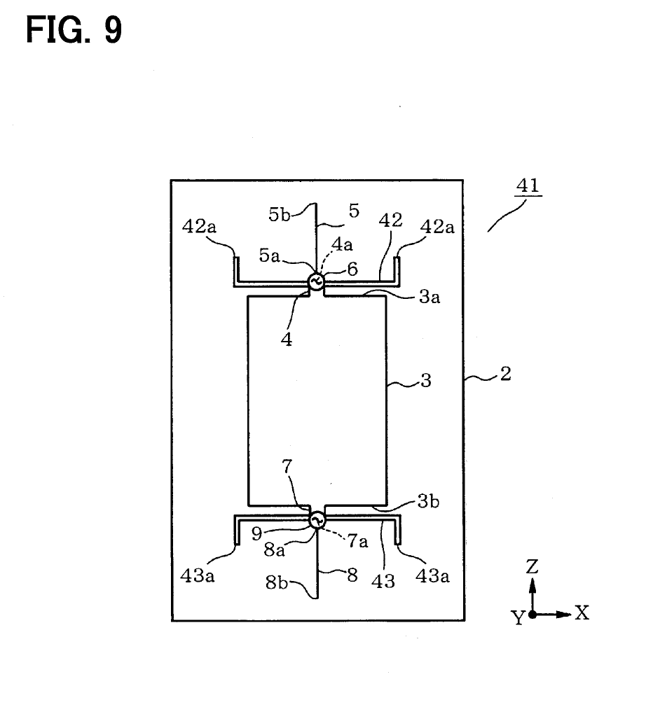

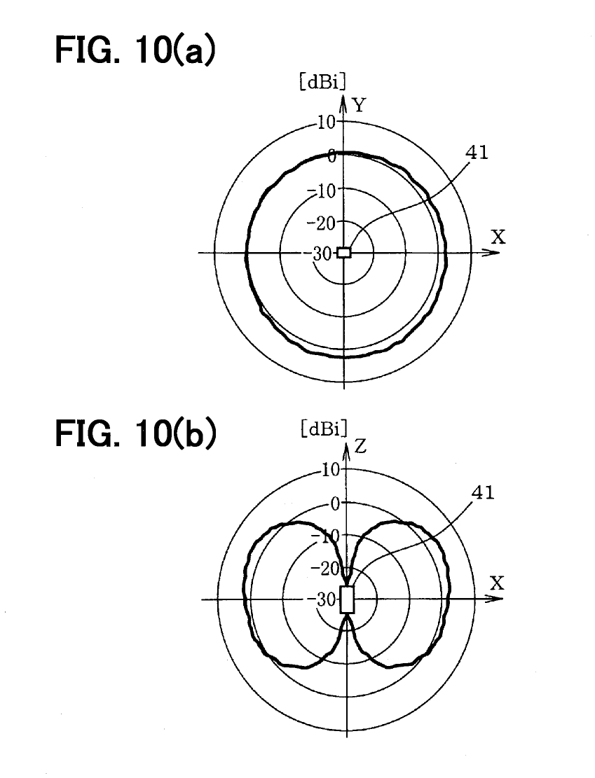

The following will describe a fourth embodiment of the present disclosure with reference to FIG. 9 to FIG. 10(b). A description of the same part with the above-described first embodiment will be omitted, and different parts will be described. A shape of the different ground pattern according to the fourth embodiment is different compared with the first embodiment.

According to the fourth embodiment, as shown in FIG. 9, in an antenna apparatus 41, in the horizontal direction, each of different ground patterns 42 and 43 has a length longer than a length of each of the upper side and the lower side of the ground pattern 3. Further, each of front end portions 42a and 43a of the different ground patterns 42 and 43 has a bent shape so that each of the front end portions 42a and 43a is bent at an approximate right angle toward a side opposite to the ground pattern 3. FIG. 10(a) and FIG. 10(b), respectively, show simulation results of a horizontal plane directivity and a vertical plane directivity of the configuration shown in FIG. 9.

In the configuration shown in FIG. 9, compared with the first embodiment in which each of the different ground patterns 10 and 11 has approximately same length with the parallel side of the ground pattern 3, each of the different ground patterns 42 and 43 has a longer length than the parallel side of the ground pattern 3 and each of the front end portions 42a and 43a is bent toward the side opposite to the ground pattern 3. Thus, a gain in the X axis direction and a gain in the Y axis direction in the simulation result of the horizontal plane directivity are further improved. Further, a generation of the null points on the X axis is avoided in the simulation result of the vertical plane directivity, and the gain in the X axis is properly secured. The fourth embodiment provides advantages similar to the advantages acquired by the first embodiment. Further, since the front end portions 42a, 43a of the different ground patterns 42 and 43 are bent at approximate right angles toward the side opposite to the ground pattern 3, a size in the horizontal direction is reduced.

### Fifth Embodiment

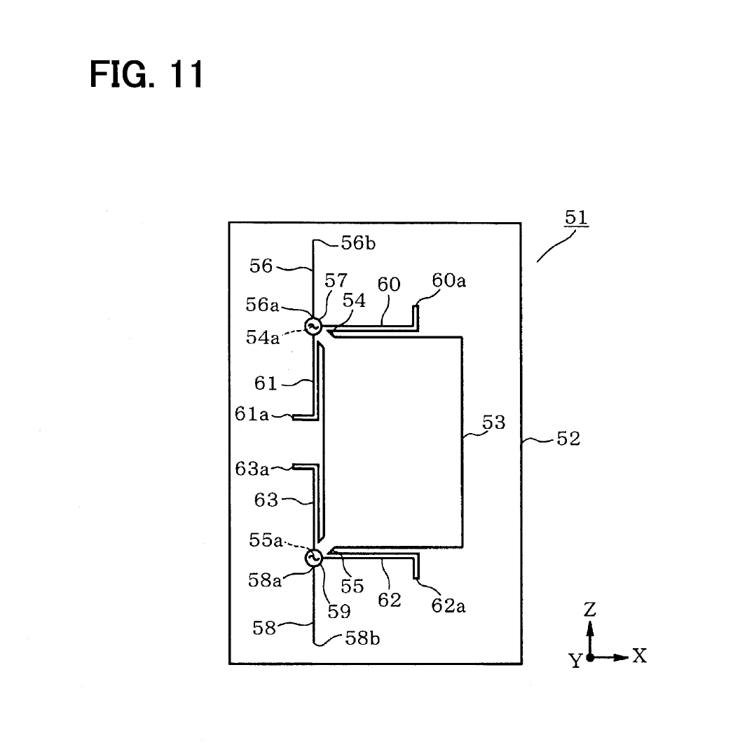

The following will describe an antenna apparatus according to a fifth embodiment of the present application with reference to FIG. 11. A description of the same part with the above-described first embodiment will be omitted, and different parts will be described. A position of the antenna element, and a position and a shape of the different ground pattern according to the fifth embodiment are different compared with the first embodiment.

According to the fifth embodiment, as shown in FIG. 11, in an antenna apparatus 51, a ground pattern 53 having an approximately rectangular shape is provided by a conductive pattern formed on a planar substrate 52. The substrate 52 has an approximately rectangular shape. The ground pattern 53 has planar approximately rectangular shape. Connection portions 54 and 55 are disposed at two corners (an upper end portion and a lower end portion at a left side on a sheet of FIG. 11) of the ground pattern 53, which are not positioned in diagonal relation, among four corners of the ground pattern 53, and the connection portions 54 and 55 protrude in oblique directions. A base end portion 56a of a monopole antenna element 56 is electrically connected with a front end portion 54a of the connection portion 54. The antenna element 56 extends in the vertical direction and is electrically connected with the ground pattern 53. That is, the antenna element 56 is connected with the connection portion 54 so that the antenna element 56 extends in a direction from the base end portion 56a toward a front end portion 56b away from the ground pattern 53. A feeding point 57 that supplies power to the antenna element 56 is provided at the base end portion 56a of the antenna element 56.

A base end portion 58a of a monopole antenna element 58 is electrically connected with a front end portion 55a of the connection portion 55. The antenna element 58 extends in the vertical direction and is electrically connected with the ground pattern 53. That is, the antenna element 58 is connected with the connection portion 55 so that the antenna element 58 extends in a direction from the base end portion 58a toward a front end portion 58b away from the ground pattern 53. A feeding point 59 that supplies power to the antenna element 58 is provided at the base end portion 58a of the antenna element 58. The antenna elements 56 and 58 are disposed symmetrically in the vertical direction, and perform a diversity reception.

At the base end portion 56a of the antenna element 56, a different ground pattern 60 is disposed along an upper side of the ground pattern 53 so that the different ground pattern 60 is approximately parallel to the upper side of the ground pattern 53, and a different ground pattern 61 is disposed along a left side of the ground pattern 53 so that the different ground pattern 61 is approximately parallel to the left side of the ground pattern 53. A front end portion 60a of the different ground pattern 60 is bent toward a side opposite to the ground pattern 53, and a front end portion 61a of the different ground pattern 61 is bent toward a side opposite to the ground pattern 53.

At the base end portion 58a of the antenna element 58, a different ground pattern 62 is disposed along a lower side of the ground pattern 53 so that the different ground pattern 62 is approximately parallel to the lower side of the ground pattern 53, and a different ground pattern 63 is disposed along the left side of the ground pattern 53 so that the different ground pattern 63 is approximately parallel to the left side of the ground pattern 53. A front end portion 62a of the different ground pattern 62 is bent toward a side opposite to the ground pattern 53, and a front end portion 63a of the different ground pattern 63 is bent toward a side opposite to the ground pattern 53.

With above-described configuration, the high frequency current flows through not only the antenna elements 56 and 58 but also the ground pattern 53. However, the high frequency current flowing through the ground pattern 53 can be restricted by disposing the different ground patterns 60 to 63. As a result, a generation of the null points in the required direction is avoided. Further, even though the null points are generated, the null points can be removed from the required direction, and the required directivity can be obtained. The fifth embodiment provides advantages similar to the advantages acquired by the first embodiment.

### Sixth Embodiment

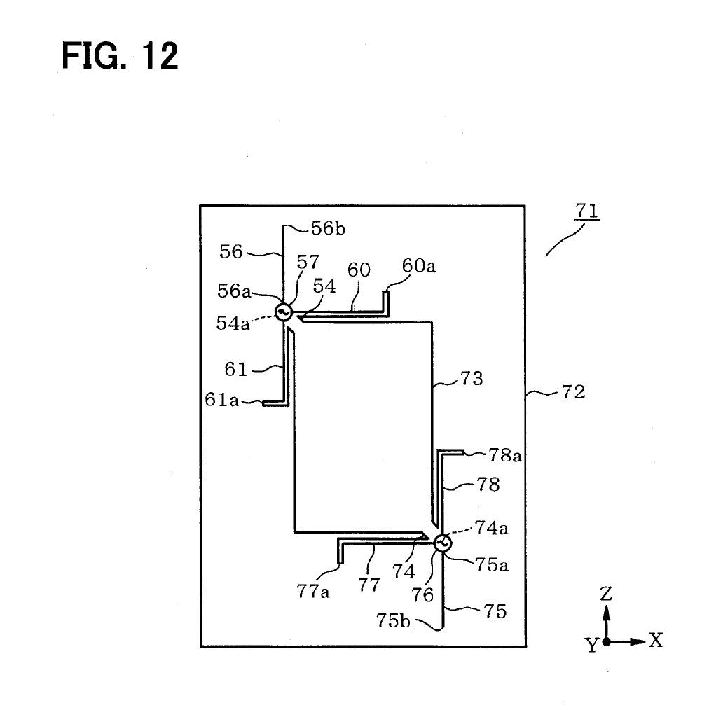

The following will describe an antenna apparatus according to a sixth embodiment of the present application with reference to FIG. 12. A description of the same part with the above-described first embodiment will be omitted, and different parts will be described. A position of the antenna element, and a position and a shape of the different ground pattern according to the sixth embodiment are different compared with the first embodiment.

According to the sixth embodiment, as shown in FIG. 12, in an antenna apparatus 71, a ground pattern 73 having approximately rectangular shape is provided by a conductive pattern formed on a planar substrate 72. The substrate 72 has an approximately rectangular shape. Connection portions 54 and 74 are disposed at two corners (an upper end portion at a left side and a lower end portion at a right side on a sheet of FIG. 12) of the ground pattern 73, which are positioned in diagonal relation, among four corners of the ground pattern 73, and the connection portions 54 and 75 protrude in oblique directions. Adjacent to the connection portion 54, the monopole antenna element 56, the feeding point 57, the different ground patterns 60 and 61 described in the fifth embodiment are disposed.

A base end portion 75a of a monopole antenna element 75 is electrically connected with a front end portion 74a of the connection portion 74. The antenna element 75 extends in the vertical direction and is electrically connected with the ground pattern 73. That is, the antenna element 75 is connected with the connection portion 74 so that the antenna element 75 extends in a direction from the base end portion 75a toward a front end portion 75b away from the ground pattern 73. A feeding point 76 that supplies power to the antenna element 75 is provided at the base end portion 75a of the antenna element 75. The antenna elements 56 and 75 are disposed symmetrically in the vertical direction, and perform a diversity reception.

At the base end portion 75a of the antenna element 75, a different ground pattern 77 is disposed along a lower side of the ground pattern 73 so that the different ground pattern 77 is approximately parallel to the lower side of the ground pattern 73, and a different ground pattern 78 is disposed along the right side of the ground pattern 73 so that the different ground pattern 78 is approximately parallel to the right side of the ground pattern 73. A front end portion 77a of the different ground pattern 77 is bent toward a side opposite to the ground pattern 73, and a front end portion 78a of the different ground pattern 78 is bent toward a side opposite to the ground pattern 73. The sixth embodiment provides advantages similar to the advantages acquired by the first embodiment.

### Seventh Embodiment

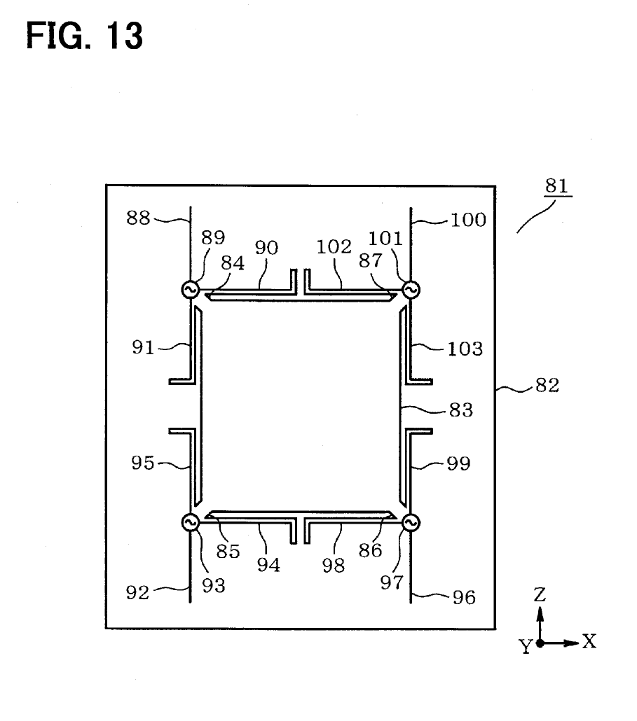

The following will describe an antenna apparatus according to a seventh embodiment of the present application with reference to FIG. 13. A description of the same part with the above-described first embodiment will be omitted, and different parts will be described. A size of the ground pattern, a quantity of the antenna elements, and a position and a shape of the different ground pattern according to the seventh embodiment are different compared with the first embodiment.

According to the seventh embodiment, as shown in FIG. 13, in an antenna apparatus 81, a ground pattern 83 having approximately rectangular shape is provided by a conductive pattern formed on a planar substrate 72. The substrate 72 has an approximately rectangular shape. The ground pattern 82 has an approximately rectangular planar shape, and connection portions 84 to 87 are formed at all of the four corners of the ground pattern and protrude in oblique directions. Adjacent to the connection portion 84, a monopole antenna element 88, a feeding point 89, and different ground patterns 90 and 91 are disposed. Adjacent to the connection portion 85, a monopole antenna element 92, a feeding point 93, and different ground patterns 94 and 95 are disposed. Adjacent to the connection portion 86, a monopole antenna element 96, a feeding point 97, and different ground patterns 98 and 99 are disposed. Adjacent to the connection portion 87, a monopole antenna element 100, a feeding point 101, and different ground patterns 102 and 103 are disposed. The seventh embodiment provides advantages similar to the advantages acquired by the first embodiment.

### Eighth Embodiment

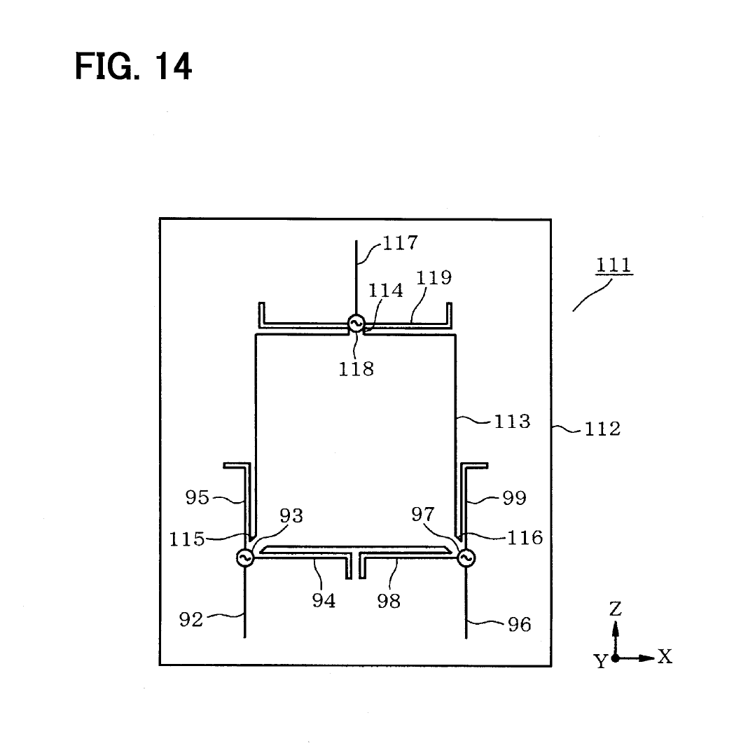

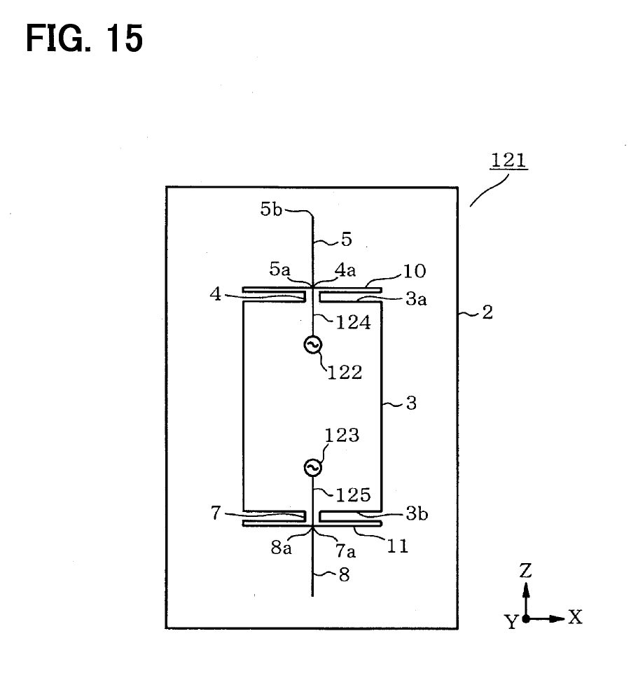

The following will describe an antenna apparatus according to an eighth embodiment of the present application with reference to FIG. 14. A description of the same part with the above-described first embodiment will be omitted, and different parts will be described. A size of the ground pattern, a quantity of the antenna elements, and a position and a shape of the different ground pattern according to the eighth embodiment are different compared with the first embodiment.

According to the eighth embodiment, as shown in FIG. 14, in an antenna apparatus 111, a ground pattern 113 having approximately rectangular shape is provided by a conductive pattern formed on a planar substrate 112. The substrate 112 has an approximately rectangular shape. The ground pattern 113 has an approximately rectangular planar shape, and connection portions 114 to 116 are formed at three portions of the ground pattern 113. Adjacent to the connection portion 114, a monopole antenna element 117, a feeding point 118, and a different ground pattern 119 are disposed. Adjacent to the connection portion 115, the monopole antenna element 92, the feeding point 93, the different ground patterns 94 and 95 described in the seventh embodiment are disposed. Adjacent to the connection portion 116, the monopole antenna element 96, the feeding point 97, the different ground patterns 98 and 99 described in the seventh embodiment are disposed. The eighth embodiment provides advantages similar to the advantages acquired by the first embodiment.

### Ninth Embodiment

The following will describe an antenna apparatus according to a ninth embodiment of the present application with reference to FIG. 15. A description of the same part with the above-described first embodiment will be omitted, and different parts will be described. A position of the feeding point according to the ninth embodiment is different compared with the first embodiment.

According to the ninth embodiment, as shown in FIG. 15, in an antenna apparatus 121, feeding points 122 and 123 are disposed at an inner side of the ground pattern 3. The base end portion 5a of the antenna element 5 is connected with the feeding point 122 via a microstripline 124. Thus, the feeding point 122 supplies power to the base end portion 5a of the antenna element 5 via the microstripline 124. The base end portion 8a of the antenna element 8 is connected with the feeding point 123 via a microstripline 123. Thus, the feeding point 123 supplies power to the base end portion 8a of the antenna element 8 via the microstripline 123. The ninth embodiment provides advantages similar to the advantages acquired by the first embodiment.

### Other Embodiments

The present disclosure is not limited to the above-described embodiments. The present disclosure can be further modified or broadened as the following.

Only one monopole antenna element may be connected with the ground pattern. That is, the diversity reception may be not performed. That is, a quantity of the antenna elements connected with single ground pattern may be set without limitation.

The monopole antenna element may be connected with the ground pattern so that the antenna element is disposed in an oblique direction (a diagonal direction of the ground pattern).

The different ground pattern may have a length asymmetry to the base end portion of the antenna element. The different ground pattern may be disposed on only one side of the base end portion of the antenna element.

A size and a shape of the monopole antenna element, a size and a shape of the ground pattern, a size and a shape of the different ground pattern may be set corresponding to the housing to be equipped to the roof of the vehicle.

The antenna element, the ground pattern, and the different ground pattern may be disposed on different surfaces of the same substrate. For example, the antenna element may be disposed on one surface of the substrate, and the ground pattern and the different ground pattern may be disposed on the other surface of the substrate. The antenna element may be electrically connected with the ground pattern and the different ground pattern by a via hole. Further, when the substrate is provided by a multi-layer substrate, the antenna element, the ground pattern, and the different ground pattern may be disposed on different layers of the same substrate. For example, the antenna element may be disposed on an outside layer, and the ground pattern and the different ground pattern may be disposed on an inside layer, and the antenna element may be electrically connected with the ground pattern and the different ground pattern by a via hole. The substrate may be provided by a bendable substrate having flexibility, or a substrate on which electronic components can be mounted on a surface thereof. That is, under a condition that the antenna element, the ground pattern, and the different ground pattern can be formed, there is no limitation to the substrate.

The vehicle antenna apparatus may also be applied to a communication system, for example, a road-to-vehicle communication system other than the vehicle-to-vehicle communication system. Further, other than the vehicle antenna apparatus, the antenna apparatus may be applied to an antenna apparatus equipped to a device other than the vehicle.

While the disclosure has been described with reference to preferred embodiments thereof, it is to be understood that the disclosure is not limited to the preferred embodiments and constructions. The disclosure is intended to cover various modification and equivalent arrangements. In addition, while the various combinations and configurations, which are preferred, other combinations and configurations, including more, less or only a single element, are also within the spirit and scope of the disclosure.

1. An antenna apparatus comprising:
a ground pattern having a conductivity and formed on a planar substrate; and
an antenna element having a linear shape and electrically connected with the ground pattern,
wherein the antenna element has a base end portion, a front end portion, and a feeding point provided at the base end portion,
wherein the ground pattern includes an end portion,
wherein the base end portion of the antenna element is connected with the end portion of the ground pattern so that the antenna element is parallel to the substrate,
wherein the antenna element is disposed so that the antenna element extends in a direction from the base end portion toward the front end portion away from the ground pattern,
wherein the antenna element is fed with power by the feeding point provided at the base end portion,
wherein an auxiliary ground patten is disposed on the substrate between the ground pattern and the antenna element,
wherein the auxiliary ground pattern is disposed along a side of the ground pattern and is electrically connected with the ground pattern at a connection portion to have a same potential with the ground pattern, and the side of the ground pattern includes the end portion of the ground pattern, and
wherein the ground pattern, the auxiliary ground pattern, and the antenna element are disposed on the substrate.

2. The antenna apparatus according to claim 1,
wherein the auxiliary ground pattern is longer than the side of the ground pattern along which the auxiliary ground pattern is disposed.

3. The antenna apparatus according to claim 1,
wherein the auxiliary ground pattern has a front end portion, and
wherein the front end portion of the auxiliary ground pattern has a bent shape that is bent toward the ground pattern.

4. The antenna apparatus according to claim 1,
wherein the auxiliary ground pattern has a front end portion, and
wherein the front end portion of the auxiliary ground pattern has a bent shape that is bent toward a direction opposite to the ground pattern.

5. The antenna apparatus according to claim 1,
wherein the auxiliary ground pattern is disposed along the side including the end portion of the ground pattern and along a side other than the side including the end portion of the ground pattern.

6. The antenna apparatus according to claim 1, further comprising:
at least one different antenna element for performing a diversity reception; and
an auxiliary ground pattern corresponding to the at least one different antenna.
